(19) United States
(12) Patent Application Publication
(10) Pub. No.: US 2022/0007266 A1
(43) Pub. Date: Jan. 6, 2022

(54) Dual Connectivity for a UE

(71) Applicant: Telefonaktiebolaget LM Ericsson (PUBL), Stockholm (SE)

(72) Inventors: Jorge Garcia Llorente, Madrid (ES); Ignacio Rivas Molina, Madrid (ES); Santiago Gallego Rodrigo, Getafe (ES)

(21) Appl. No.: 17/299,448

(22) PCT Filed: Jan. 15, 2019
(86) PCT No.: PCT/EP2019/050946

§ 371 Date: Jun. 3, 2021

(30) Foreign Application Priority Data
Dec. 10, 2018 (EP) 18382903.5

(51) Int. Cl. H04W 48/04; H04W 76/15; H04W 8/24

(52) U.S. Cl. CPC H04W 48/04; H04W 8/24; H04W 76/15

(57) ABSTRACT

There is provided mechanisms for handling dual connectivity for a UE. A method is performed by a mobility node. The method comprises: obtaining, from a network node, an indication that the UE supports dual connectivity to a first radio access network and a second radio access network. The method comprises forwarding the indication towards a policy node. The method comprises obtaining information originating from the policy node. The information specifies whether the policy node has determined to allow or restrict access to the second radio access network for the UE. The method comprises forwarding the information towards the network node.

### TECHNICAL FIELD

Embodiments presented herein relate to methods, a mobility node, a policy node, a system, computer programs, and a computer program product for handling dual connectivity for a User Equipment (UE).

### BACKGROUND

In communications networks, there may be a challenge to obtain good performance and capacity for a given communications protocol, its parameters and the physical environment in which the communications network is deployed.

The Policy and Charging Rules Function (PCRF) is the functional element that encompasses policy control decision and flow based charging control functionalities. It provides network and gating control, and manages the flow based charging. The PCRF could be configured to instruct the Mobility Management Entity (MME) to select the packet data network gateway PGW for a UE when the UE attaches to the network. The PCRF could further be configured to provide the MME with RAT/Frequency Selection Priority (RFSP) and a list of event-triggers for notifications for the UE.

The radio access network node (such as an evolved NodeB; eNB) could be configured to control a dual connectivity radio connection that uses a combination of a fourth generation (4G) radio access network and a fifth generation (5G) radio access network with the 5G radio access network as a secondary radio access technology (RAT) using the evolved packet core (EPC) network in a Non-Standalone (NSA) configuration when the 5G-capable UEs are simultaneously associated both with eNB and a radio access network node (such as a gNodeB; gNB) in the 5G radio access network.

Currently, the decision on whether access to the 5G radio access network for a UE is restricted or not is taken by the MME and is based on Home Subscriber Server (HSS) subscription data, indication of UE support for the 5G radio access network, and local MME configurations. This could result in a lack of flexibility since it could be difficult to set different configurations for different UEs.

Hence, there is a need for an improved way to determine whether access to the 5G radio access network for a UE is restricted or not.

### SUMMARY

An object of embodiments herein is to provide efficient handling dual connectivity between a first radio access network and a second radio access network for a UE that enables efficient determination as to whether access to the second radio access network for a UE is restricted or not.

According to a first aspect there is presented a method for handling dual connectivity for a UE. The method is performed by a mobility node. The method comprises obtaining, from a network node, an indication that the UE supports dual connectivity to a first radio access network and a second radio access network. The method comprises forwarding the indication towards a policy node. The method comprises obtaining information originating from the policy node. The information specifies whether the policy node has determined to allow or restrict access to the second radio access network for the UE. The method comprises forwarding the information towards the network node.

According to a second aspect there is presented a mobility node for handling dual connectivity for a UE. The mobility node comprises processing circuitry. The processing circuitry is configured to cause the mobility node to obtain, from a network node, an indication that the UE supports dual connectivity to a first radio access network and a second radio access network. The processing circuitry is configured to cause the mobility node to forward the indication towards a policy node. The processing circuitry is configured to cause the mobility node to obtain information originating from the policy node. The information specifies whether the policy node has determined to allow or restrict access to the second radio access network for the UE. The processing circuitry is configured to cause the mobility node to forward the information towards the network node.

According to a third aspect there is presented a computer program for handling dual connectivity for a UE. The computer program comprises computer program code which, when run on processing circuitry of a mobility node, causes the mobility node to perform a method according to the first aspect.

According to a fourth aspect there is presented a method for handling dual connectivity for a UE. The method is performed by a policy node. The method comprises obtaining, from a mobility node, an indication that the UE supports dual connectivity to a first radio access network and a second radio access network. The method comprises determining whether to allow or restrict access to the second radio access network for the UE. The method comprises providing information towards the mobility node. The information specifies whether the policy node has determined to allow or restrict access to the second radio access network for the UE.

According to a fifth aspect there is presented a policy node for handling dual connectivity for a UE. The policy node comprises processing circuitry. The processing circuitry is configured to cause the policy node to obtain, from a mobility node, an indication that the UE supports dual connectivity to a first radio access network and a second radio access network. The processing circuitry is configured to cause the policy node to determine whether to allow or restrict access to the second radio access network for the UE. The processing circuitry is configured to cause the policy node to provide information towards the mobility node. The information specifies whether the policy node has determined to allow or restrict access to the second radio access network for the UE.

According to an sixth aspect there is presented a computer program for handling dual connectivity for a UE, the computer program comprising computer program code which, when run on processing circuitry of a policy node, causes the policy node to perform a method according to the fourth aspect.

According to a seventh aspect there is presented a computer program product comprising a computer program according to at least one of the third aspect and the sixth aspect and a computer readable storage medium on which the computer program is stored. The computer readable storage medium could be a non-transitory computer readable storage medium.

According to an eighth aspect there is presented a system. The system comprises a mobility node according to the second aspects and a policy node according to the fifth aspect.

Advantageously these methods, this mobility node, this policy node, these computer programs, this computer program product, and this system provide efficient determination as to whether access to the second radio access network for a UE is restricted or not.

Advantageously these methods, this mobility node, this policy node, these computer programs, this computer program product, and this system enable access to the second radio access network to be flexibly adapted.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 3 are flowcharts of methods according to embodiments;

FIG. 4 is a signalling diagram according to an embodiment;

FIG. 5 is a schematic diagram showing functional units of a mobility node according to an embodiment;

FIG. 6 is a schematic diagram showing functional modules of a mobility node according to an embodiment;

FIG. 7 is a schematic diagram showing functional units of a policy node according to an embodiment;

FIG. 8 is a schematic diagram showing functional modules of a policy node according to an embodiment; and

FIG. 9 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

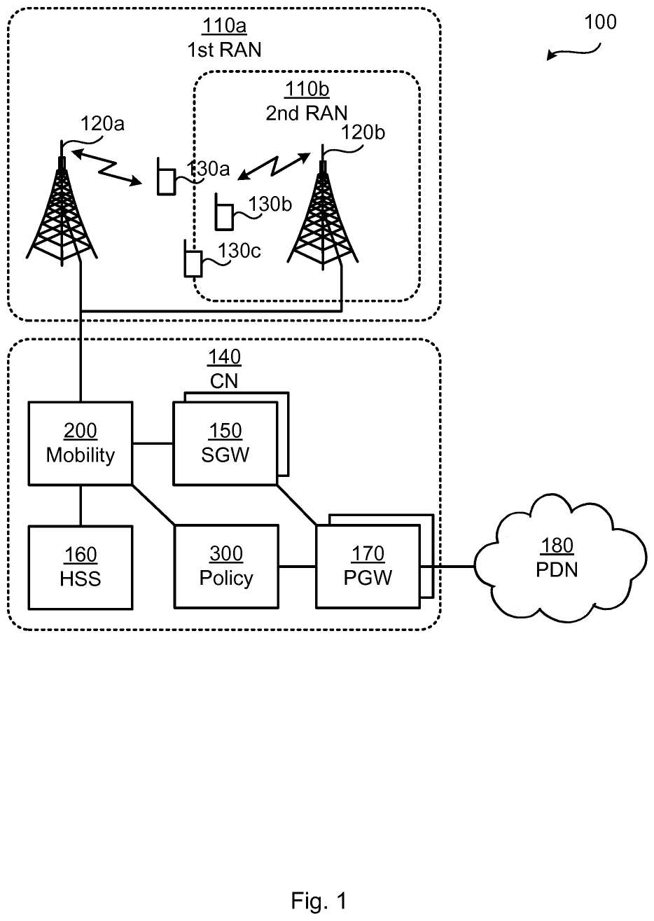

FIG. 1 is a schematic diagram illustrating a communications network 100 where embodiments presented herein can be applied. The communications network 100 comprises a first radio access network (RAN) 110a comprising a network node 120a for providing network access to UEs 130a, 130b, 130c using a first radio access technology. The communications network 100 further comprises a second radio access network 110b comprising a network node 120b for providing network access to UEs 130a, 130b, 130c using a second radio access technology. In case the first radio access technology is 4G radio access, the second radio access technology could be 5G radio access. Hence, the network node 120a could provide 4G network access to UEs 130a, 130b, 130c and the network node 120b could provide 5G network access to UEs 130a, 130b, 130c. Hence, the first radio access network 110a could be a 4G radio access network and the second radio access network 110b could be a 5G radio access network.

The network node 120a could be an eNB and the network node 120b could be a gNB. Examples of UEs 130a, 130b, 130c are wireless devices, mobile stations, mobile phones, handsets, wireless local loop phones, smartphones, laptop computers, tablet computers, network equipped sensors, network equipped vehicles, and so-called Internet of Things devices. The radio access networks 110a, 110b are operatively connected to a core network (CN) 140. The core network 140 comprises at least one serving gateway 150, at least one packet gateway 170, a HSS 160, a mobility node 200, and a policy node 300 having at least those operable connections and interfaces as illustrated in FIG. 1. The core network 140 is in turn operatively connected to a packet data network (PDN) 180. The UEs 130a, 130b, 130c are thereby enabled to, via the network nodes 120a, 120b, access services of, and exchange data with, the packet data network 180. In some aspects the functionality of the mobility node 200 is implemented in an MME or similar. In some aspects the functionality of the policy node 300 is implemented in a PCRF or similar.

In the illustrative example of FIG. 1 the second radio access network 110b can be regarded as a secondary RAT using the core network 140 in an NSA configuration. As disclosed above there is a need for an improved way to determine whether access to the second radio access network nob for a UE 130a, 130b, 130c is restricted or not In further detail, according to current procedures, access control in NSA deployments to second radio access networks 110b is provided only based on static parameters. The UE 130a, 130b, 130c indicates support of Dual Connectivity with NR (DCNR) in the UE Network Capability Information Element (IE) provided in the Attach Request and in the Tracking Area Update (TAU) Request. Access to second radio access networks 110b is allowed if 1) the UE 130a, 130b, 130c supports this, 2) the HSS subscription data does not statically restrict this, and 3) the mobility node 200 does not have any local static configuration that restricts this for the subscriber of the UE 130a, 130b, 130c.

According to at least some of the herein disclosed embodiments, access control for a UE 130a, 130b, 130c to second radio access networks 110b is extended to be based on dynamic decisions taken by policy node 300. The embodiments disclosed herein in particular relate to mechanisms for handling dual connectivity for a UE 130a, 130b, 130c. In order to obtain such mechanisms there is provided a mobility node 200, a method performed by the mobility node 200, a computer program product comprising code, for example in the form of a computer program, that when run on processing circuitry of the mobility node 200, causes the mobility node 200 to perform the method. In order to obtain such mechanisms there is further provided a policy node 300, a method performed by the policy node 300, and a computer program product comprising code, for example in the form of a computer program, that when run on processing circuitry of the policy node 300, causes the policy node 300 to perform the method.

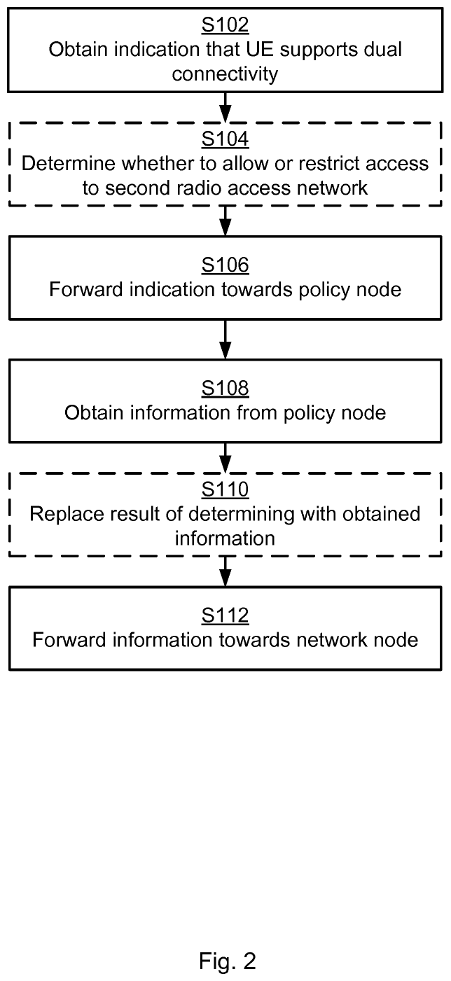

Reference is now made to FIG. 2 illustrating a method for handling dual connectivity for a UE 130a, 130b, 130c as performed by the mobility node 200 according to an embodiment.

As noted above, the UE 130a, 130b, 130c might indicate that it supports dual connectivity. Hence, the mobility node 200 is configured to perform step S102:

S102: The mobility node 200 obtains, from a network node 120a, 120b, an indication that the UE 130a, 130b, 130c supports dual connectivity to a first radio access network 110a and a second radio access network 110b.

Since access control is to be dynamically decided upon by the policy node 300, the indication is forwarded towards the policy node 300. Thus, the mobility node 200 is configured to perform step S106:

S106: The mobility node 200 forwards the indication towards the policy node 300.

As will be further disclosed below, once the policy node 300 has determined whether to allow or restrict access to the second radio access network 110b for the UE 130a, 130b, 130c, it forwards information about its decision towards the mobility node 200. In particular, the mobility node 200 is configured to perform step S108:

S108: The mobility node 200 obtains information originating from the policy node 300. The information specifies whether the policy node 300 has determined to allow or restrict access to the second radio access network 110b for the UE 130a, 130b, 130c.

The mobility node 200, when obtaining the information from the policy node 300, takes into account this information and forwards the information to the network node 120a, 120b in the communication network too. In order for access to the second radio access network 110b for the UE 130a, 130b, 130c to be allowed or restricted the information thus needs to be communicated to the network node 120a, 120b. Hence, the mobility node 200 is configured to perform step S112:

S112: The mobility node forwards the information towards the network node 120a, 120b.

This method allows the service network operator to differentiate UEs 130a, 130b, 130c, thus providing dynamically the best optimization and traffic management of the network based on dynamic conditions.

Embodiments relating to further details of handling dual connectivity for a UE 130a, 130b, 130c as performed by the mobility node 200 will now be disclosed.

There may be different types of indications that the mobility node 200 obtains in step S102. In some aspects the indication specifies that NR is allowed as secondary RAT for the UE 130a, 130b, 130c. That is, according to an embodiment the indication specifies that the second radio access network 110b is allowed as a secondary RAT for the UE 130a, 130b, 130c. The indication might be obtained in an Attach Request message or in a Tracking Area Update (TAU) request message for the UE 130a, 130b, 130c. In more detail, if the UE 130a, 130b, 130c supports dual connectivity with NR, then the UE 130a, 130b, 130c shall set the DCNR bit to “dual connectivity with NR supported” in the UE network capability IE of the Attach Request and Tracking Area Update (TAU) request messages. Hence, according to an embodiment, the indication is given as a DCNR bit in a UE network capability IE.

There may be different ways for the mobility node 200 to forward the indications in step S106. According to an embodiment the indication is forwarded in a Credit Control Request (CCR) message. In more detail, the CCR message as sent from the mobility node 200 towards the policy node 300 could have the following structure:
<CC-Request>::=<Diameter Header: 272, REQ, PXY>
   [ . . . ]
   [UE-DCNR]

The UE-DCNR Attribute-Value Pair (AVP) is a new AVP that is added to the CCR messages in order to indicate that the UE 130a, 130b, 130c is NR capable as secondary RAT (i.e., that the UE 130a, 130b, 130c supports dual connectivity to a first radio access network 110a and a second radio access network 110b).

There may be different ways for the mobility node 200 to obtain the information in step S110. According to an embodiment the information is obtained in a Credit Control Answer (CCA) message. In more detail, the CCA message as sent from the policy node 300 to the mobility node 200 could have the following structure:
<CC-Answer>::=<Diameter Header: 272, PXY>
   [ . . . ]
   [DCNR-Restriction]

The DCNR-Restriction AVP is a new AVP that is added to the CCA message in order to indicate whether the use of NR as secondary RAT is restricted or not (i.e., whether the policy node 300 has determined to allow or restrict access to the second radio access network 110b for the UE 130a, 130b, 130c).

In some aspects the mobility node 200 and the policy node 300 communicate over a Diameter Smp interface. Particularly, according to an embodiment the indication is forwarded (as in step S106), and the information is obtained (as in step S108), over a Diameter Smp interface between the mobility node 200 and the policy node 300. Information about NR restrictions can be passed over the Diameter Smp interface from the policy node 300 to the mobility node 200 using pull/push modes. For example, dynamic NR restrictions can be provided by the policy node 300 to the mobility node 200 in a pull mode (such after a CCR message from the mobility node 200) or in a push mode (such as in a policy node originating Reauthorization Request (RAR) to the mobility node 200).

As disclosed above, currently the decision on whether access to the second radio access network 110b for a UE 130a, 130b, 130c is restricted or not is taken by the mobility node 200. The herein disclosed embodiments can be combined with a mobility node 200 making such a legacy decision. Hence, according to an embodiment the mobility node 200 is configured to perform (optional) step S104:

S104: The mobility node 200 determines, before obtaining the information from the policy node 300, whether to allow or restrict access to the second radio access network 110b for the UE 130a, 130b, 130c based on at least one parameter having a static value.

The at least one parameter having a static value could be any of: Home Subscriber Server (HSS) subscription data, indication of UE support for the second radio access network 110b, and local MME configurations.

Once the mobility node 200 obtains the information in step S108, this information might overwrite a result of the determining in step S104. Hence, according to an embodiment the mobility node 200 is configured to perform (optional) step S110:

S110: The mobility node 200 replaces a result of the determining with the obtained information.

That is, the dynamic configuration (as defined by the information obtained from the policy node 300 in step S108) might overwrite the static configuration (as defined by the result of the determining in step S104).

There may be different ways for the mobility node 200 to provide the information in step S112. In some aspects the mobility node 200 in an Attach Accept message or a TAU Accept NAS message restricts the use of dual connectivity with NR for the UE 130a, 130b, 130c. That is, according to an embodiment, the information is provided in an attach accept response message or in a tracking area update accept message for the UE 130a, 130b, 130c. The network node 120a, 120b then acts accordingly and thus either allows or restricts access to the second radio access network 110b for the UE 130a, 130b, 130c based on the information provided from the mobility node 200 in step S112.

In some aspects the information is provided as a RestrictDCNR bit in an Evolved packet system (EPS) Network Feature Support IE. The network node 120a, 120b then restricts the use of dual connectivity with NR for the UE 130a, 130b, 130c when the MME sets the RestrictDCNR bit to indicate that use of dual connectivity with NR is restricted.

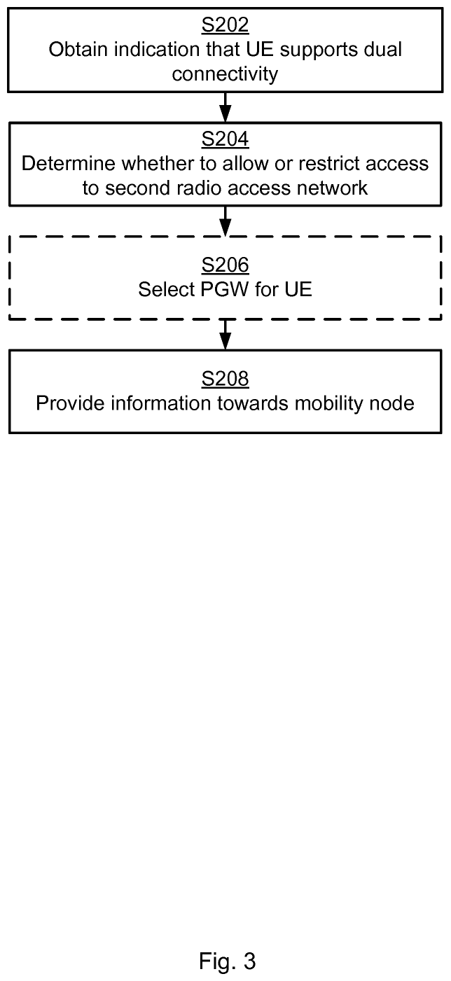

Reference is now made to FIG. 3 illustrating a method for handling dual connectivity for a UE 130a, 130b, 130c as performed by the policy node 300 according to an embodiment.

As disclosed above, the mobility node 200 forwards the indication that the UE 130a, 130b, 130c supports dual connectivity to a first radio access network 110a and a second radio access network 110b towards the policy node 300. Hence, the policy node 300 is configured to perform step S202:

S202: The policy node 300 obtains, from a mobility node 200, an indication that the UE 130a, 130b, 130c supports dual connectivity to a first radio access network 110a and a second radio access network 110b.

The policy node 300 takes dynamically the decision about the restriction or not of the NR access as secondary RAT using EPC in an NSA configuration. Access control for the UE 130a, 130b, 130c to the second radio access network 110b is thus based on a dynamic decision taken by policy node 300. Particularly, the policy node 300 is configured to perform step S204:

S204: The policy node 300 determines whether to allow or restrict access to the second radio access network 110b for the UE 130a, 130b, 130c.

The decision of whether to allow or restrict access to the second radio access network 110b for the UE 130a, 130b, 130c is then forwarded to the mobility node 200. Particularly, the policy node 300 is configured to perform step S208:

S208: The policy node 300 provides information towards the mobility node 200. The information specifies whether the policy node 300 has determined to allow or restrict access to the second radio access network 110b for the UE 130a, 130b, 130c.

Also this method allows the service network operator to differentiate UEs 130a, 130b, 130c, thus providing dynamically the best optimization and traffic management of the network based on dynamic conditions.

Embodiments relating to further details of handling dual connectivity for a UE 130a, 130b, 130c as performed by the policy node 300 will now be disclosed.

There might be different types of indications that the policy node 300 obtains in step S202. In some aspects the indication specifies that NR is allowed as secondary RAT for the UE 130a, 130b, 130c. That is, according to an embodiment the indication specifies that the second radio access network 110b is allowed as a secondary radio access technology, RAT, for the UE 130a, 130b, 130c. As above, according to an embodiment, the indication is given as a DCNR bit in a UE network capability IE

There could be different conditions, parameters, properties, and/or factors that the policy node 300 uses when determining whether to allow or restrict access to the second radio access network 110b for the UE 130a, 130b, 130c in step S204. In general terms, the policy node 300 makes the decision by evaluating a number of policy rules that are configured by the network operator. Those policy rules contain conditions (e.g. that a parameter should be equal to, larger than, or smaller than, a value, etc.), and the appropriate decision that applies when the condition is met (e.g. allow or restrict access to the second radio access network 110b for the UE 130a, 130b, 130c). Particularly, according to an embodiment, whether to allow or restrict access to the second radio access network 110b for the UE 130a, 130b, 130c is based on the policy node 300 evaluating a policy rule with respect to at least one parameter having a dynamically changing value.

According to an embodiment the at least one parameter having a dynamically changing value pertains to: UE subscriber category, location information of the UE 130a, 130b, 130c, accumulated resource use for the UE 130a, 130b, 130c, service type for the UE 130a, 130b, 130c, time conditions, network conditions, and/or interface conditions. In some aspects the policy node 300 determines whether to allow or restrict access to the second radio access network 110b for the UE 130a, 130b, 130c in step S204 based on events on interfaces, such as any of the Gx, Rx, Sd, Sy interfaces. NR access in NSA deployments can thereby be controlled based on subscriber category, accumulated use, service type, and access and time conditions, etc.

There might be different ways for policy node 300 to obtain the indication from the mobility node 200 in step S102. As above, according to an embodiment the indication is obtained in a CCR message.

There might be different ways for policy node 300 to provide the information towards the mobility node 200 in step S208. According to an embodiment the information is provided in a CCA message.

As above, in some aspects the mobility node 200 and the policy node 300 communicate over a Diameter Smp interface. Particularly, according to an embodiment the indication is obtained (as in step S202), and the information is provided (as in step S208), over a Diameter Smp interface between the policy node 300 and the mobility node 200.

For example, the policy node 300 might determine to restrict access to the second radio access network 110b for UEs 130a, 130b, 130c of certain subscriber categories. For example, the policy node 300 might determine to restrict access to the second radio access network 110b for UEs 130a, 130b, 130c based on current network conditions. For example, the policy node 300 might determine to, during busy hours, or depending on the location, restrict the access to the second radio access network 110b for UEs 130a, 130b, 130c of certain subscriber categories. For example, the policy node 300 might determine to restrict access to the second radio access network 110b for UEs 130a, 130b, 130c based on dynamic or subscribed services. For example, the policy node 300 might determine to restrict access to the second radio access network 110b based on specific time frames and locations (e.g. during work hours or a specific sports event), based on load conditions (if a network node 120a, 120b is overloaded access to the second radio access network 110b be allowed or restricted), based on information received from other interfaces (e.g. when a specific Internet Protocol Multimedia Subsystem (IMS) application is started or stopped; when traffic from a specific application is detected (e.g. based on deep packet inspection (DPI)).

In addition to determining whether to allow or restrict access to the second radio access network 110b for the UE 130a, 130b, 130c the policy node 300 might select a packet gateway based on the determining. Thus, according to an embodiment the policy node 300 is configured to perform (optional) step S206:

S206: The policy node 300 selects a packet gateway, such as a PGW, for the UE 130a, 130b, 130c based on the determining whether to allow or restrict access to the second radio access network 110b for the UE 130a, 130b, 130c.

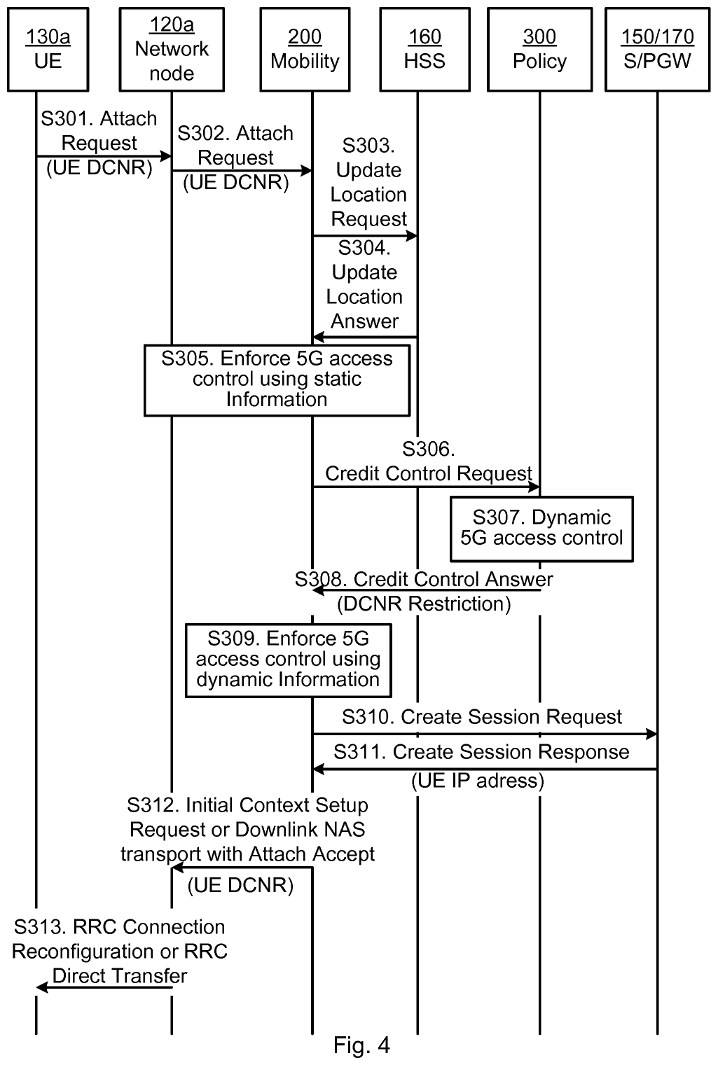

One particular embodiment for handling dual connectivity for the UE 130a, 130b, 130c based on at least some of the above disclosed embodiments will now be disclosed in detail with reference to the signalling diagram of FIG. 4.

S301: The UE 130a, 130b, 130c sends an Attach Request message to the network node 120a. The UE 130a, 130b, 130c has in the Attach Request set the DCNR bit to “dual connectivity with NR supported” in the UE network capability IE.

S302: The network node 120a forwards the Attach Request message to the mobility node 200. The mobility node 200 thereby obtains, from the network node 120a, an indication that the UE 130a, 130b, 130c supports dual connectivity to a first radio access network 110a and a second radio access network 110b.

S303: The mobility node 200, based on the Attach Request message, sends an update location request message to the HSS 160.

S304: The HSS responds by sending a update location accept message to the mobility node 200.

S305: The mobility node 200 makes a decision on whether access to the second radio access network 110b for the UE 130a, 130b, 130c based on HSS subscription data, indication of UE support for the second radio access network 110b, and local MME configurations. The mobility node 200 thereby determines whether to allow or restrict access to the second radio access network 110b for the UE 130a, 130b, 130c based on at least one parameter having a static value.

S306: The mobility node 200 sends a CCR message to the policy node 300. The CCR message comprises the UE-DCNR AVP. The mobility node 200 thereby forwards the indication towards the policy node 300 and the policy node 300 thereby obtains, from the mobility node 200, an indication that the UE 130a, 130b, 130c supports dual connectivity to a first radio access network 110a and a second radio access network 110b.

S307: The policy node 300 takes dynamically the decision about the restriction or not of the NR access as secondary RAT using EPC in an NSA configuration. The policy node 300 thereby determines whether to allow or restrict access to the second radio access network 110b for the UE 130a, 130b, 130c.

S308: The policy node 300 responds with a CCA message to the mobility node 200, where the CCA message comprises a DCNR-Restriction AVP. The policy node 300 thereby provides information towards the mobility node 200, and the mobility node 200 thereby obtains information from the policy node 300.

S309: The mobility node 200 replaces a result of the determining in step S305 with the information obtained in step S308. That is, the dynamic configuration (as defined by the information obtained from the policy node 300 in step S308) overwrites the static configuration (as defined by the result of the determining in step S305).

S310: The mobility node 200 sends create session request for the UE 130a, 130b, 130c to the SGW 150 and/or PGW 170 as defined by the DCNR-Restriction AVP.

S311: The SGW 150 and/or PGW 170 having received the create session request responds with a create session response with an Internet Protocol (IP) address for the UE 130a, 130b, 130c.

S312: The mobility node 200 sends an initial context setup request message or a downlink NAS transport with Attach Accept message to the network node 120a based on the DCNR-Restriction AVP.

S313: The network node 120a configures the UE 130a, 130b, 130c with a radio resource control (RRC) connection reconfiguration message or an RRC direct transfer message based on the DCNR-Restriction AVP.

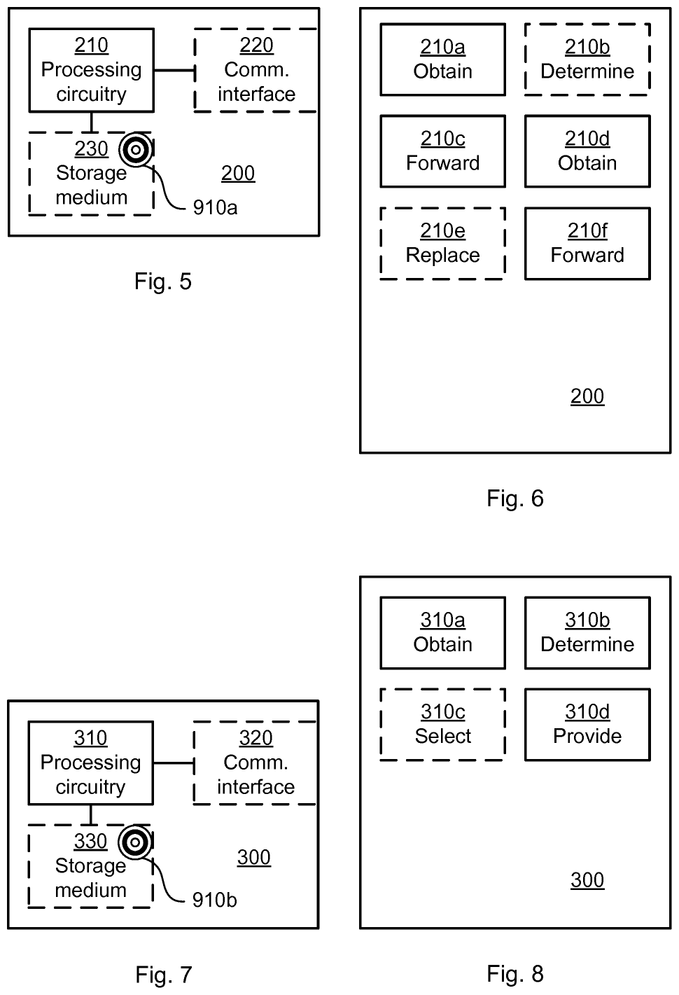

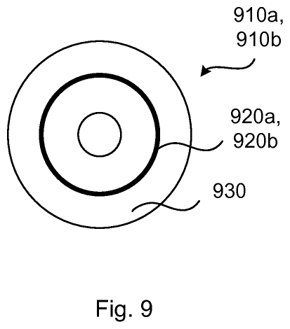

FIG. 5 schematically illustrates, in terms of a number of functional units, the components of a mobility node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910a (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the mobility node 200 to perform a set of operations, or steps, as disclosed above. For example, the storage medium 230 may store the set of operations, and the processing circuitry 210 may be configured to retrieve the set of operations from the storage medium 230 to cause the mobility node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The mobility node 200 may further comprise a communications interface 220 for communications with other entities, nodes, functions, and devices of the communication network 100. As such the communications interface 220 may comprise one or more transmitters and receivers, comprising analogue and digital components.

The processing circuitry 210 controls the general operation of the mobility node 200 e.g. by sending data and control signals to the communications interface 220 and the storage medium 230, by receiving data and reports from the communications interface 220, and by retrieving data and instructions from the storage medium 230. Other components, as well as the related functionality, of the mobility node 200 are omitted in order not to obscure the concepts presented herein.

FIG. 6 schematically illustrates, in terms of a number of functional modules, the components of a mobility node 200 according to an embodiment. The mobility node 200 of FIG. 6 comprises a number of functional modules; an obtain module 210a configured to perform step S102, a forward module 210c configured to perform step S106, an obtain module 210d configured to perform step S108, and a forward module 210f configured to perform step S112. The mobility node 200 of FIG. 6 may further comprise a number of optional functional modules, such as any of a determine module 210b configured to perform step S104, and a replace module 210e configured to perform step S110. In general terms, each functional module 210a-210f may be implemented in hardware or in software. Preferably, one or more or all functional modules 210a-210f may be implemented by the processing circuitry 210, possibly in cooperation with the communications interface 220 and/or the storage medium 230. The processing circuitry 210 may thus be arranged to from the storage medium 230 fetch instructions as provided by a functional module 210a-210f and to execute these instructions, thereby performing any steps of the mobility node 200 as disclosed herein.

FIG. 7 schematically illustrates, in terms of a number of functional units, the components of a policy node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 910b (as in FIG. 9), e.g. in the form of a storage medium 330. The processing circuitry 310 may further be provided as at least one application specific integrated circuit (ASIC), or field programmable gate array (FPGA).

Particularly, the processing circuitry 310 is configured to cause the policy node 300 to perform a set of operations, or steps, as disclosed above. For example, the storage medium 330 may store the set of operations, and the processing circuitry 310 may be configured to retrieve the set of operations from the storage medium 330 to cause the policy node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The policy node 300 may further comprise a communications interface 320 for communications with other entities, nodes, functions, and devices of the communication network too. As such the communications interface 320 may comprise one or more transmitters and receivers, comprising analogue and digital components.

The processing circuitry 310 controls the general operation of the policy node 300 e.g. by sending data and control signals to the communications interface 320 and the storage medium 330, by receiving data and reports from the communications interface 320, and by retrieving data and instructions from the storage medium 330. Other components, as well as the related functionality, of the policy node 300 are omitted in order not to obscure the concepts presented herein.

FIG. 8 schematically illustrates, in terms of a number of functional modules, the components of a policy node 300 according to an embodiment. The policy node 300 of FIG. 8 comprises a number of functional modules; an obtain module 310a configured to perform step S202, a determine module 310b configured to perform step S204, and a provide module 310d configured to perform step S208. The policy node 300 of FIG. 8 may further comprise a number of optional functional modules, such as a select module 310c configured to perform step S206. In general terms, each functional module 310a-310d may be implemented in hardware or in software. Preferably, one or more or all functional modules 310a-310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a-310d and to execute these instructions, thereby performing any steps of the policy node 300 as disclosed herein.

The mobility node 200 and/or policy node 300 may be provided as a standalone device or as a part of at least one further device. For example, the mobility node 200 and/or policy node 300 may be provided in a node of the core network. Alternatively, functionality of the mobility node 200 and/or policy node 300 may be distributed between at least two devices, or nodes. These at least two nodes, or devices, may either be part of the same network part (such as the core network) or may be spread between at least two such network parts.

Thus, a first portion of the instructions performed by the mobility node 200 and/or policy node 300 may be executed in a first device, and a second portion of the of the instructions performed by the mobility node 200 and/or policy node 300 may be executed in a second device; the herein disclosed embodiments are not limited to any particular number of devices on which the instructions performed by the mobility node 200 and/or policy node 300 may be executed. Hence, the methods according to the herein disclosed embodiments are suitable to be performed by a mobility node 200 and/or policy node 300 residing in a cloud computational environment. Therefore, although a single processing circuitry 210, 310 is illustrated in FIGS. 5 and 7 the processing circuitry 210, 310 may be distributed among a plurality of devices, or nodes. The same applies to the functional modules 210a-210f, 310a-310d of FIGS. 6 and 8 and the computer programs 920a, 920b of FIG. 9.

FIG. 9 shows one example of a computer program product 910a, 910b comprising computer readable means 930. On this computer readable means 930, a computer program 920a can be stored, which computer program 920a can cause the processing circuitry 210 and thereto operatively coupled entities and devices, such as the communications interface 220 and the storage medium 230, to execute methods according to embodiments described herein. The computer program 920a and/or computer program product 910a may thus provide means for performing any steps of the mobility node 200 as herein disclosed. On this computer readable means 930, a computer program 920b can be stored, which computer program 920b can cause the processing circuitry 310 and thereto operatively coupled entities and devices, such as the communications interface 320 and the storage medium 330, to execute methods according to embodiments described herein. The computer program 920b and/or computer program product 910b may thus provide means for performing any steps of the policy node 300 as herein disclosed.

In the example of FIG. 9, the computer program product 910a, 910b is illustrated as an optical disc, such as a CD (compact disc) or a DVD (digital versatile disc) or a Blu-Ray disc. The computer program product 910a, 910b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920a, 920b is here schematically shown as a track on the depicted optical disk, the computer program 920a, 920b can be stored in any way which is suitable for the computer program product 910a, 910b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for handling dual connectivity for a User Equipment, UE, the method being performed by a mobility node, the method comprising:
obtaining, from a network node, an indication that the UE supports dual connectivity to a first radio access network and a second radio access network;
forwarding the indication towards a policy node;
obtaining information originating from the policy node, the information specifying whether the policy node has determined to allow or restrict access to the second radio access network for the UE; and
forwarding the information towards the network node.

2. The method according to claim 1, wherein the indication specifies that the second radio access network is allowed as a secondary radio access technology, RAT, for the UE.

3. The method according to claim 1, wherein the indication is obtained in an attach request message or in a tracking area update request message for the UE.

4. The method according to claim 1, wherein the indication is given as a Dual Connectivity with New Radio, DCNR, bit in a UE network capability information element, IE.

5. The method according to claim 1, wherein the indication is forwarded in a Credit Control Request, CCR, message; and wherein the information is obtained in a Credit Control Answer, CCA, message.

6. (canceled)

7. The method according to claim 1, wherein the indication is forwarded, and the information is obtained, over a Diameter Smp interface between the mobility node and the policy node.

8. The method according to claim 1, further comprising:
determining, before obtaining the information from the policy node, whether to allow or restrict access to the second radio access network for the UE based on at least one parameter having a static value.

9. The method according to claim 8, further comprising:
replacing a result of the determining with the obtained information.

10. The method according to claim 1, wherein the information is provided in an attach accept response message or in a tracking area update accept message for the UE.

11. A method for handling dual connectivity for a User Equipment, UE, the method being performed by a policy node, the method comprising:
obtaining, from a mobility node, an indication that the UE supports dual connectivity to a first radio access network and a second radio access network;
determining whether to allow or restrict access to the second radio access network for the UE; and
providing information towards the mobility node, the information specifying whether the policy node has determined to allow or restrict access to the second radio access network for the UE.

12. The method according to claim 11, wherein the indication specifies that the second radio access network is allowed as a secondary radio access technology, RAT, for the UE.

13. The method according to claim 11, wherein whether to allow or restrict access to the second radio access network for the UE is based on the policy node evaluating a policy rule with respect to at least one parameter having a dynamically changing value.

14. The method according to claim 11, wherein the at least one parameter pertains to: UE subscriber category, location information of the UE, accumulated resource use for the UE, service type for the UE, time conditions, network conditions, and/or interface conditions.

15. The method according to claim 11, wherein the indication is obtained in a Credit Control Request, CCR, message; and wherein the information is provided in a Credit Control Answer, CCA, message.

16. (canceled)

17. The method according to claim 11, wherein the indication is obtained, and the information is provided, over a Diameter Smp interface between the policy node and the mobility node.

18. The method according to claim 11, further comprising:
selecting a packet gateway, PGW, for the UE based on the determining whether to allow or restrict access to the second radio access network for the UE.

19. A mobility node for handling dual connectivity for a User Equipment, UE, the mobility node comprising processing circuitry, the processing circuitry being configured to cause the mobility node to:
obtain, from a network node, an indication that the UE supports dual connectivity to a first radio access network and a second radio access network;
forward the indication towards a policy node;
obtain information originating from the policy node, the information specifying whether the policy node has determined to allow or restrict access to the second radio access network for the UE; and
forward the information towards the network node.

20. The mobility node according to claim 19, wherein the indication specifies that the second radio access network is allowed as a secondary radio access technology, RAT, for the UE.

21. A policy node for handling dual connectivity for a User Equipment, UE, the policy node comprising processing circuitry, the processing circuitry being configured to cause the policy node to:
obtain, from a mobility node, an indication that the UE supports dual connectivity to a first radio access network and a second radio access network;
determine whether to allow or restrict access to the second radio access network for the UE; and
provide information towards the mobility node, the information specifying whether the policy node has determined to allow or restrict access to the second radio access network for the UE.

22. The policy node according to claim 21, wherein the indication specifies that the second radio access network is allowed as a secondary radio access technology, RAT, for the UE.

23.-26. (canceled)
